(19) United States
(12) Patent Application Publication
(10) Pub. No.: US 2007/0055527 A1
(43) Pub. Date: Mar. 8, 2007

(54) Method for synthesizing various voices by controlling a plurality of voice synthesizers and a system therefor

(75) Inventors: Myeong-Gi Jeong, Suwon-si (KR); Young-Hee Park, Seoul (KR); Jong-Chang Lee, Suwon-si (KR); Hyun-Sik Shim, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/516,865

(22) Filed: Sep. 7, 2006

(30) Foreign Application Priority Data
Sep. 7, 2005 (KR) 2005-83086

(51) Int. Cl. G10L 13/08

(52) U.S. Cl. 704/260

(57) ABSTRACT

Disclosed is a voice synthesis system for performing various voice synthesis functions. At least one voice synthesizer synthesizes voices, and a TTS (Text-To-Speech) matching unit for controlling the voice synthesizer converts a text coming from a client apparatus into voices by analyzing the text. The system also includes a background sound mixer for mixing a background sound with the synthesized voices received from the voice synthesizer, and a modulation effective device for imparting sound-modulation effect to the synthesized voices. Thus, the system provides the user with more services by generating synthesized voices imparted with various effects.

### PRIORITY

This application claims priority under 35 U.S.C. § 119 to an application entitled “METHOD FOR SYNTHESIZING VARIOUS VOICES BY CONTROLLING A PLURALITY OF VOICE SYNTHESIZERS AND A SYSTEM THEREFOR” filed in the Korean Intellectual Property Office on Sep. 7, 2005 and assigned Serial No. 2005-83086, the contents of which are incorporated herein by reference.

### BACKGROUND OF THE INVENTION

1. Field of the Invention

The present invention relates to a method and system for synthesizing various voices by using Text-To-Speech (TTS) technology.

2. Description of the Related Art

Generally, the voice synthesizer converts text into audible voice sounds. To this end, the TTS technology is employed to analyze the text and then synthesize the voices speaking the text.

The conventional TTS technology is employed to synthesize a single speech voice for one language. Namely, the conventional voice synthesizer has the function for generating the voices speaking the text with only one voice. Accordingly, it has no means for generating various aspects of the voice as desired by the user, i.e., varying language, sex, tone, etc.

For example, the voice synthesizer featuring “Korean+male+adult” only synthesizes voices featuring a Korean male adult, so that the user cannot vary parts of the text spoken. Thus, the conventional voice synthesizer provides only a single voice, and therefore cannot synthesize varieties of voices to meet various requirements of the users according to such services as news, email, etc. In addition, the monotonic voice speaking the whole text can disinterest and bore the user.

Moreover, tone modulation technology is problematic if be employed in order to synthesize varieties of voices because it cannot meet the user's requirements of using a text editor to impart colors to parts of the text. Thus, there has not been proposed a voice-synthesizing unit including a plurality of voice synthesizers for synthesizing different voices that may be selectively used for different parts of the text.

As described above, the conventional method for synthesizing a voice employs only one voice synthesizer, and cannot provide the user with various voices reflecting various speaking characteristics such as language, sex, and age.

### SUMMARY OF THE INVENTION

It is an object of the present invention to provide a method and system for synthesizing various characteristics of voices used for speaking a text by controlling a plurality of voice synthesizers.

According to the present invention, a voice synthesis system for performing various voice synthesis functions by controlling a plurality of voice synthesizers includes a client apparatus for providing a text with tags defining the attributes of the text to produce a tagged text as a voice synthesis request message, a TTS matching unit for analyzing the tags of the voice synthesis request message received from the client apparatus to select one of the plurality of voice synthesizers, the TTS matching unit delivering the text with the tags converted to the selected synthesizer, and the TTS matching unit delivering the voices synthesized by the synthesizer to the client apparatus, and a synthesizing unit composed of the plurality of voice synthesizers for synthesizing the voices according to the voice synthesis request received from the TTS matching unit.

According to the present invention, a voice synthesis system including a client apparatus, TTS matching unit, and a plurality of voice synthesizers, is provided with a method for performing various voice synthesis functions by controlling the voice synthesizers, which includes causing the client apparatus to supply the TTS matching unit with a voice synthesis request message composed of a text attached with tags defining the attributes of the text, causing the TTS matching unit to select one of the voice synthesizers by analyzing the tags of the message, causing the TTS matching unit to convert the tags of the text into a format to be recognized by the selected synthesizer based on a tag table containing a collection of tags previously stored for the plurality of voice synthesizers, causing the TTS matching unit to deliver the text with the tags converted to the selected synthesizer and then to receive the voices synthesized by the synthesizer, and causing the TTS matching unit to deliver the voices to the client apparatus.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram for illustrating a voice synthesis system according to the present invention;

FIG. 2 is a flowchart for illustrating the steps of synthesizing a voice in the inventive voice synthesis system;

FIG. 3 is a schematic diagram for illustrating a voice synthesis request message according to the present invention;

FIG. 4 is a tag table according to the present invention; and

FIG. 5 is a schematic diagram for illustrating the procedure of synthesizing a voice according to the present invention.

### DETAILED DESCRIPTION OF THE PREFERRED EMBODIMENT

Throughout the descriptions of the embodiments connected to the drawings, detailed descriptions of the conventional parts not required to comprehend the technical concept of the present invention are omitted for the sake of clarity and conciseness.

In order to impart colors to voice synthesis, the system includes a plurality of voice synthesizers, and a TTS matching unit for controlling the voice synthesizers to synthesize a voice according to a text coming from a client apparatus. The system is also provided with a background sound mixer for mixing a background sound with a voice synthesized by the synthesizer, and a modulation effective device for imparting a modulation effect to the synthesized voice, thus producing varieties of voices.

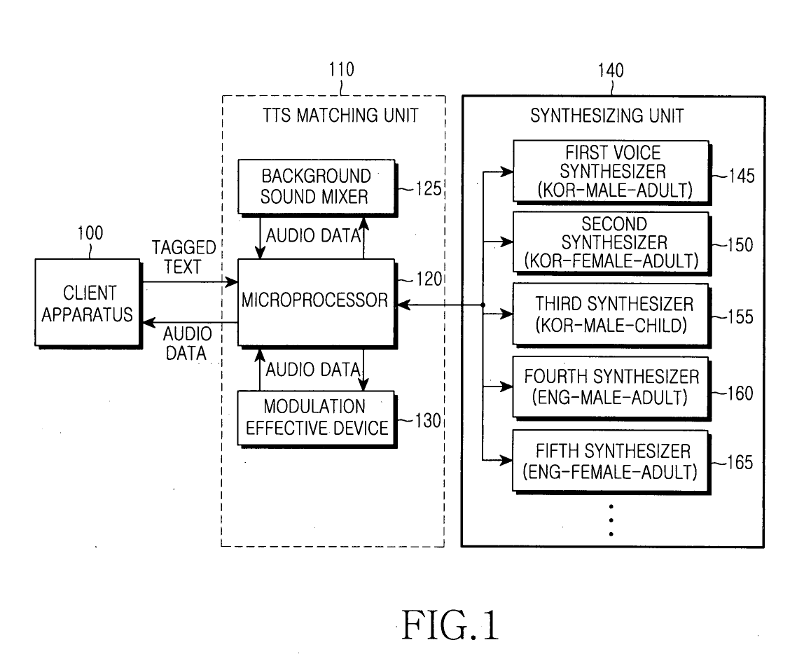

In FIG. 1, the voice synthesis system includes a client apparatus 100 for attaching to a text a tag defining the attributes (e.g., speech speed, effect, modulation, etc.) of the text, a TTS matching unit 110 for analyzing the tag of the text to produce a tagged text, and a synthesizing unit 140 composed of the synthesizers for synthesizing voices fitting the text under the control of the TTS matching unit.

Hereinafter the client apparatus 100, TTS matching 110, and synthesizing unit 140 are described in detail. The client apparatus 100 includes various apparatuses like a robot, delivering a text prepared by the user to the TTS matching unit 110. Namely, the client apparatus 100 delivers the text as a voice synthesis request message to the TTS matching unit 110, representing all the connection nodes for receiving the voices synthesized according to the voice synthesis request message. To this end, the client apparatus 100 attaches tags to the text to form a tagged text delivered to the TTS matching unit 110, which tags are interpreted by the synthesizers to impart various effects to the synthesized voices. In detail, the tags are used to order the synthesizers to impart various effects to parts of the text.

The tagged text is prepared by using a GUI (Graphic User Interface) writing tool provided in a PC or Web, wherein the tags define the attributes of the text. The writing tool enables the user or service provider to select various voice synthesizers to impart various effects to the synthesized voices speaking the text. For example, using this tool, the user may arbitrarily set phrase intervals in the text to have different voices synthesized by different synthesizers. In addition, the writing tool may be provided with a pre-hearing function for the user to hear the synthesized voices prior to use.

The TTS matching unit 110 also serves to impart additional effects to the synthesized voices received from the synthesizing unit according to the additional tags. The TTS matching unit 110 includes a microprocessor 120 for analyzing the tagged text received from the client apparatus, background sound mixer 125 for imparting a background sound to the synthesized voice, and modulation effective device 130 for sound-modulating the synthesized voice. Thus, the TTS matching unit 110 may include various devices for imparting various effects in addition to voice synthesis.

The background sound mixer 125 serves to mix a background sound such as music to the synthesized voice according to the additional tags defining the background sound contained in the tagged text received from the client apparatus 100. Likewise, the modulation effective device 130 serves to impart sound-modulation to the synthesized voice according to the additional tags.

More specifically, the microprocessor 120 analyzes the tags of the tagged text coming from the client apparatus 100 to deliver the tagged text to the voice synthesizer of the synthesizing unit 140 selected based on the analysis. To this end, the microprocessor 120 uses common standard tags for effectively controlling a plurality of voice synthesizers of the synthesizing unit 140 in order to convert the tagged text into the format fitting the voice synthesizer. Of course, the microprocessor 120 may deliver the tagged text to the synthesizer without converting into another format.

The synthesizing unit 140 includes a plurality of various voice synthesizers for synthesizing various voices in various languages according to a voice synthesis request from the microprocessor 120. For example, as shown in FIG. 1, the synthesizing unit 140 may include a first voice synthesizer 145 for synthesizing a Korean adult male voice, a second voice synthesizer 150 for synthesizing a Korean adult female voice, a third voice synthesizer 155 for synthesizing a Korean male child voice, a fourth voice synthesizer 160 for synthesizing an English adult male voice, and a fifth voice synthesizer 165 for synthesizing an English adult female voice.

Such an individual voice synthesizer employs TTS technology to convert the text coming from the microprocessor 120 into its inherent voice. In this case, the text delivered from the microprocessor 120 to each voice synthesizer may be a part of the whole text. For example, if the user divides the text into a plurality of speech parts to be converted by different voice synthesizers into different voices by setting the tags, the microprocessor 120 delivers the speech parts to their respective voice synthesizers to produce differently synthesized voices. Subsequently, the microprocessor 120 combines the different voices from the synthesizing unit in the proper order so as to deliver the final integrated voices speaking the entire text to the client apparatus 100.

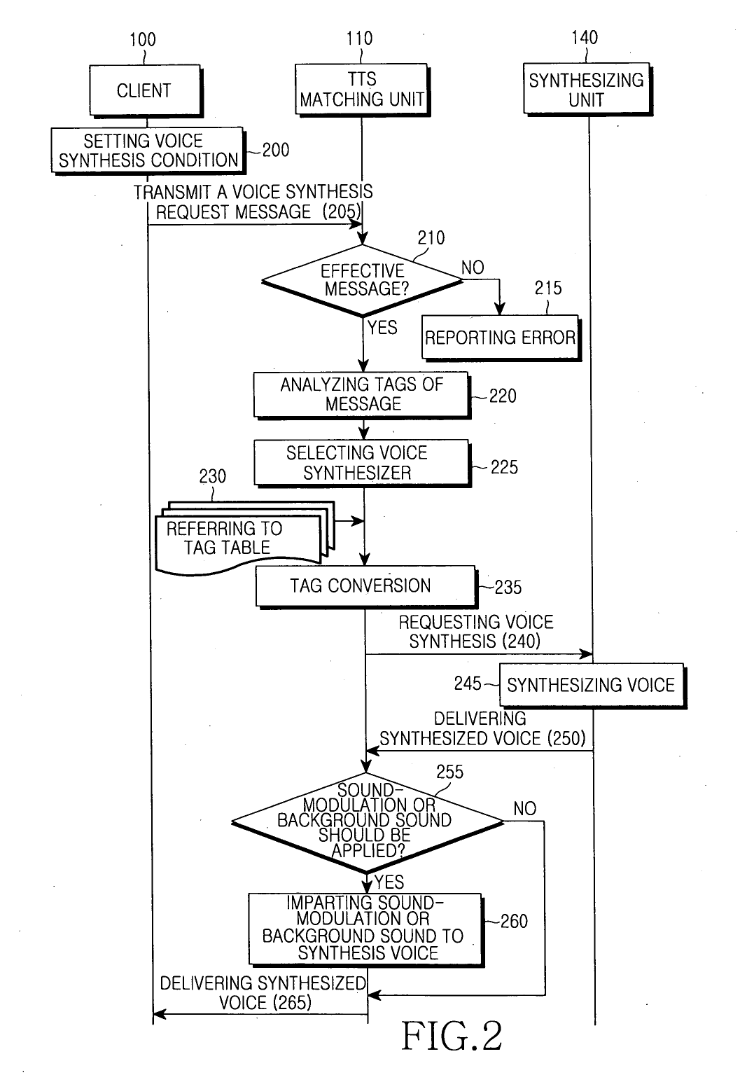

FIG. 2 describes the operation of the system for synthesizing various characteristic voices for a text. In FIG. 2, the user prepares a tagged text with the tags defining its attributes by using a GUI writing tool, thus setting a voice synthesis condition in step 200. Then the client apparatus 100 delivers a voice synthesis request message containing the voice synthesis condition to the TTS matching unit 110 in step 205. The voice synthesis request message is the tagged text, actually inputted to the microprocessor 120 in the TTS matching unit 110. Then the microprocessor 120 goes to step 210 to determine by analyzing the format of the message whether it is effective. More specifically, the microprocessor 120 checks the header of the received message to determine whether the message is a voice synthesis request message prepared according to a prescribed message rule. Namely, the received message should have a format readable by the microprocessor 120. For example, the present embodiment may follow xml format. Alternatively, it may follow SSML (Speech Synthesis Markup Language) format recommended by the world wide web consortium (W3C). An example of the xml message field representing the header is shown in Table 1.

TABLE 1

<?tts version=“1.0” proprietor=“urc” ?>

In Table 1, “version” represents the version of the message rule used, and “proprietor” represents the scope of applying the message rule.

If the result of checking the header indicates that the message is not in an effective format, the microprocessor 120 goes to step 215 to report error, terminating further analysis of the message. Alternatively, if the message is effective, the microprocessor 120 goes to step 220 to analyze the tags of the message in order to determine which voice synthesizers may be used to produce synthesized voices.

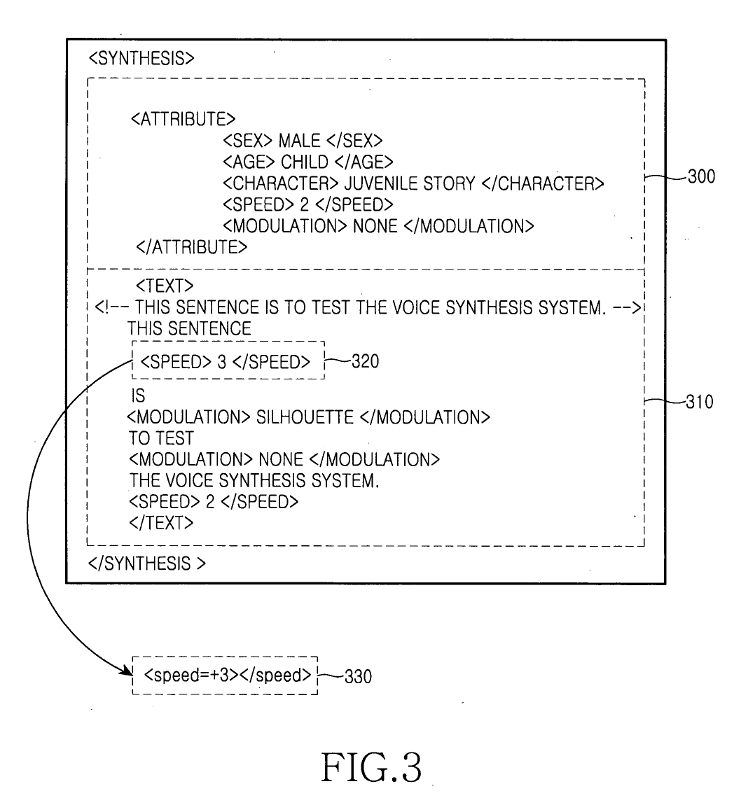

Referring to FIG. 3, the voice synthesis procedure according to the present invention is more specifically described by synthesizing a male child voice of an example sentence “This sentence is to test the voice synthesis system” in the manner of telling a juvenile story. In this case, the speed of outputting the synthesized voice is set to have basic value “2” with no modulation.

In FIG. 3, the microprocessor 120 analyzes the tags defining the attributes of the sentence indicated by reference numeral 300 to determine the type of voice synthesizer to use. Although FIG. 3 shows xml format as an example, there may be used SSML format or other standard tags defined by a new format. If the synthesizer allows application of voice speed adjustment and sound-modulation filter, the microprocessor 120 delivers data defining such effects.

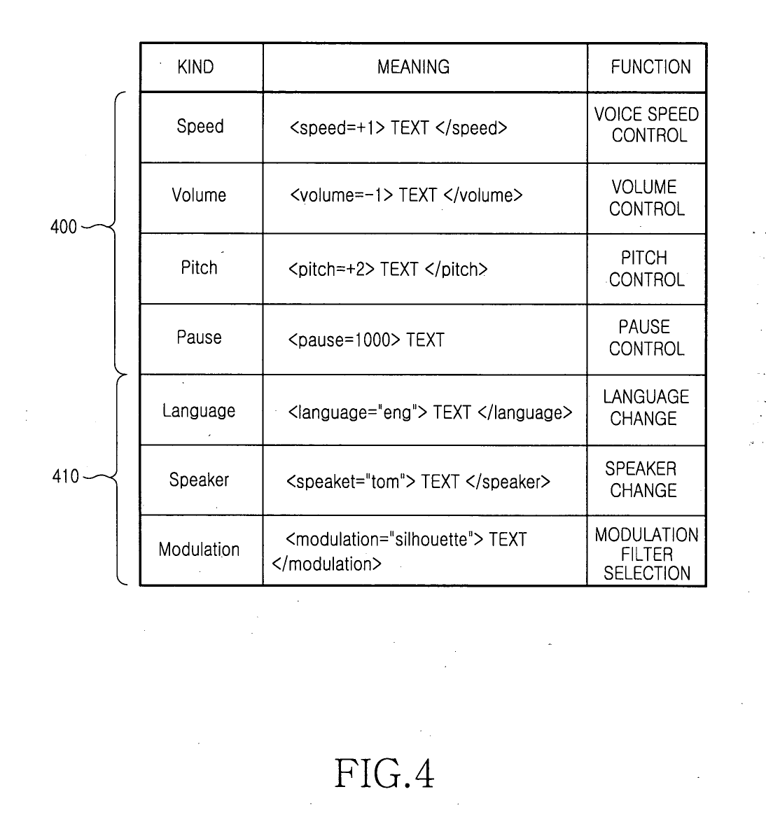

Thus, with the voice synthesizer selected, the microprocessor 120 goes to step 235 to convert the tags in step 230 to a tag table as shown in FIG. 4. The tag table represents the collection of the tags previously stored for every voice synthesizers. The tag table is referred to on tag conversion so that the microprocessor properly controls multiple voice synthesizers.

Referring to FIG. 3, reference numeral 310 represents the part actually used by the voice synthesizer in which the text is divided into several parts attached with different tags. Namely, the microprocessor 120 converts the tags in the part 310 into another format readable by the voice synthesizers. For example, the part indicated by reference numeral 320 may be converted into a format indicated by reference numeral 330.

Thus, analyzing the part indicated by reference numeral 310, the microprocessor 120 recognizes the voice speed of the sentence part “is to test the voice” as value “3”, and the phrase “to test” as to be imparted with silhouette modulation effect. Then the microprocessor 120 goes to step 240 to request a voice synthesis by delivering the tags to the voice synthesizer for synthesizing a male child voice.

Accordingly, the third voice synthesizer 155 of the synthesizing unit 140 synthesizes in step 245 a male child voice delivered to the microprocessor 120 in step 250. Then the microprocessor 120 goes to step 255 to determine whether sound-modulation or background sound should be applied. If sound-modulation or background sound should be applied, the microprocessor 120 goes to step 260 to impart sound-modulation or background sound to the synthesized voice. In this case, the background sound is obtained by mixing the sound data with the same resolution as that of the synthesized voice.

Referring to FIG. 3, because “silhouette” is requested for the sound-modulation, the microprocessor 120 modulates the synthesized voice with the data corresponding to “silhouette” received from the modulation effective device 130 in the TTS matching unit 110. Then the microprocessor 120 goes to step 265 to deliver the final synthesized voice thus obtained to the client apparatus 100, which outputs the synthesized male child voice with the phrase “to test” only imparted with “silhouette” modulation.

The tags usable for the TTS matching unit 110 are as shown in FIG. 4. The part represented by reference numeral 400 of the tags may be used for the voice synthesizers, while the part represented by reference numeral 410 is used for the TTS matching unit 110. Thus, receiving a voice synthesis request message with tags of voice speed, volume, pitch, pause, etc., the microprocessor 120 performs the tag conversion referring to the tag table as shown in FIG. 4.

More specifically, “Speed” is a command for controlling the voice speed of the data, and for example, <speed+1> TEXT </speed> means to make the voice speed of the text within the tag interval be increased to one level more than the basic speed. “Volume” is a command for controlling the voice volume of the data, and for example, <volume+1> TEXT </volume> means to make the voice volume of the text within the tag interval be decreased by one level less than the basic speed. “Pitch” is a command for controlling the voice tone of the data, and for example, <pitch+2> TEXT </pitch> means to make the voice tone of the text within the tag interval be increased to two levels more than the basic speed. “Pause” is a command for controlling the pause interval inserted, and for example, <pause=1000> TEXT means to insert a pause of one second before the text is converted into a voice. Thus, receiving such tags from the microprocessor 120, the voice synthesizers synthesize voices with control of voice speed, volume, pitch, and pause.

Meanwhile, “Language” is a command for requesting change of language; and for example, <language=“eng”> TEXT </language> means to request the voice synthesizer speaking English. Accordingly, receiving a voice synthesis request message attached with such tag, the microprocessor 120 selects the voice synthesizer speaking English. “Speaker” is a command for requesting change of speaker, and for example, <speaker=“tom”> TEXT </speaker> means to make the voice synthesizer named “tom” synthesize a voice representing the text within the tag interval. “Modulation” is a command for selecting a modulation filter for modulating the synthesized voice, and for example, <modulation=“silhouette”> TEXT </modulation> means to make the synthesized voice of the text within the tag interval be imparted with “silhouette” modulation. In this manner, the microprocessor 120 imparts desired modulation effects to the synthesized voice coming from the synthesizing unit.

As described above, receiving a voice synthesis request message attached with such tags from the client apparatus 100, the TTS matching unit 110 can not only change speaker and language, but also impart sound-modulation and background sound to the synthesized voice, according to the tags.

Alternatively, if the tag is represented by using SSML rules recommended by W3C, the tag command for selecting the voice synthesizer is “voice” instead of “speaker” as in the previous embodiment. Hence, the xml message field for selecting the voice synthesizer is as shown in Table 2.

TABLE 2

<voice name=‘Mike’> Hello, My name is Mike.</voice>

In Table 2, “voice” represents the name of the field, and the attribute of the field is represented by “name”, used for the microprocessor 120 of the TTS matching unit 110 to select the voice synthesizer previously defined. If the attribute is omitted, the default synthesizer is selected.

In addition, “emphasis” is a tag command for emphasizing the text, expressed in the message field as shown in Table 3.

TABLE 3

This is <emphasis> my </emphasis> car!
That is <emphasis level=“strong”> your </emphasis> car.

In Table 3, “emphasis” is a field for emphasizing the text within a selected interval, and its value is represented by “level” representing the degree of emphasis. If the value is omitted, the default level is applied.

In addition, “break” is a tag command for inserting a pause, expressed in the message field as shown in Table 4.

TABLE 4

Inhale deep <break/> Exhale again.
Push button No. 1 and wait for a beep. <break time = “3s”/>
Hard of hearing. <break strength = “weak”/> Please speak again.

In Table 4, “break” serves to insert the pause interval declared in the field between synthesized voices, having attributes of “time” or “strength”, which attributes have values to define the pause interval.

“Prosody” is a tag command for expressing prosody, expressed in the message field as shown in Table 5.

TABLE 5

This article costs <prosody rate = “−10%”> 380 </prosody> dollars.

In Table 5, “prosody” serves to represent the synthesized prosody of the selected interval, having such attributes as “rate”, “volume”, “pitch” and “range”, which attributes have values to define the prosody applied to the selected interval.

“Audio” is a tag command for expressing sound effect, expressed in the field as shown in Table 6.

TABLE 6

<audio src = “welcome.wav”> Welcome to you visiting us. </audio>

In Table 6, “audio” serves to impart a sound effect to the synthesized voice, having attribute of “src” to define the sound effect.

“Modulation” is a tag command for representing modulation effect, expressed in the message field as shown in Table 7.

TABLE 7

<modulation name=“DarthVader”>I am your father. </modulation>

In Table 7, “modulation” serves to impart modulation effect to the synthesized voice, having the attribute of “name” to define the modulation filter applied to the synthesized voice.

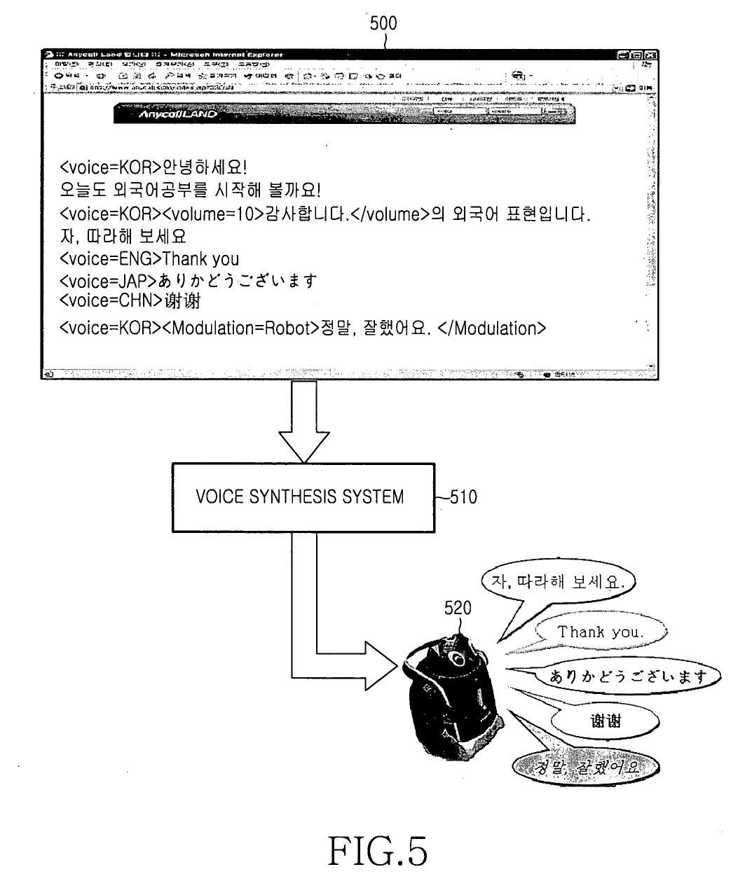

Describing the use of such tag commands with reference to FIG. 5, the voice synthesis request message has tag commands as indicated by reference numeral 500, processed in the voice synthesis system 510. Namely, if the voice synthesis request message is delivered to the TTS matching unit 110, checked effective, the TTS matching unit analyzes the tag commands to determine which voice synthesizer is to be selected. For example, using the tag command of this embodiment, the microprocessor 120 checks the attribute of “name” among the elements of the “voice” tag command to select the proper voice synthesizer. If the voice synthesizer is selected, the tags of the message inputted are converted into the format readable by the voice synthesizer based on the tag table mapping the tag list applied to the voice synthesizer to the standard message tag list. In this case, it is desirable that the microprocessor 120 stores temporarily the tags of sound-modulation and sound effect instead of converting in order to apply them to the synthesized voice received from the voice synthesizer. Then, after delivering the voice synthesis request message with the converted tags to the voice synthesizer, the microprocessor 120 stands by for receiving the output of the voice synthesizer.

Subsequently, receiving the voice synthesis request message, the voice synthesizer synthesizes the voices fitting the data of the message delivered to the microprocessor 120. Receiving the synthesized voices, the microprocessor 120 checks the temporarily stored tags to determine whether the request message from the client apparatus 100 included a sound-modulation request. If there was the sound-modulation request, the microprocessor 120 retrieves the data for performing the sound-modulation from the sound effective device 130 to impart the sound-modulation to the synthesized voices. Likewise, if it is checked that the request message from the client apparatus 100 included sound effect imparting request, the microprocessor 120 retrieves the data of the sound effect from the background sound mixer 125 to mix the sound effect with the synthesized voices. The synthesized voices thus obtained are delivered to the client apparatus 100 such as a robot as represented by reference numeral 520, thereby resulting in varieties of voice synthesis effects.

As described above, the present invention not only provides means for effectively controlling various voice synthesizers to produce synthesized voices of different characters, but also improves quality of service by employing more complex voice synthesis applications. Moreover, interactive apparatuses employing the inventive voice synthesis system can provide the user with different synthesized voices according to various requirements of the user such as narrating a juvenile story or reading an email.

While the present invention has been described in connection with specific embodiments accompanied by the attached drawings, it will be readily apparent to those skilled in the art that various changes and modifications may be made thereto without departing from the spirit and scope of the present invention.

What is claimed is:

1. A voice synthesis system for performing various voice synthesis functions by controlling a plurality of voice synthesizers, comprising:
a client apparatus for providing a text with tags defining attributes of said text to produce a tagged text as a voice synthesis request message;
a Text-To-Speech (TTS) matching unit for analyzing the tags of said voice synthesis request message received from said client apparatus to select one of said plurality of voice synthesizers, said TTS matching unit delivering said text with the tags converted to the selected synthesizer, and said TTS matching unit delivering voices synthesized by said synthesizer to said client apparatus; and
a synthesizing unit composed of said plurality of voice synthesizers for synthesizing said voices according to the voice synthesis request received from said TTS matching unit.

2. A system as defined in claim 1, wherein said TTS matching unit comprises:
a microprocessor for analyzing the tags of said voice synthesis request message to determine whether said attributes include a modulation effect and a sound effect, said microprocessor producing the voices synthesized combined with modulation and sound data;
a modulation effective device for supplying said modulation data to said microprocessor to apply the modulation effect to said voices if said voice synthesis request message includes the attribute of modulation effect; and
a background sound mixer for supplying said sound data to said microprocessor to apply the sound effect to said voices if said voice synthesis request message includes the attribute of sound effect.

3. A system as defined in claim 2, wherein said microprocessor analyzes the tags of said voice synthesis request message only if said message is determined to be effective after analyzing a format of said message.

4. A system as defined in claim 1, wherein said TTS matching unit converts the tags of said text into a format to be recognized by said selected synthesizer based on a tag table obtained by mapping a tag list applicable to said selected synthesizer to standard message tag list.

5. A system as defined in claim 1, wherein said synthesizing unit comprises said plurality of voice synthesizers for synthesizing voices according to different languages and different ages and for adjusting a speed, intensity, tone, and pause of said voices.

6. A system as defined in claim 1, wherein said voice synthesis request message is the tagged text including said text and the tags defining the attributes thereof, said text and tags composed by the user through a GUI (Graphic User Interface) writing tool.

7. In a voice synthesis system including a client apparatus, a TTS (Text-To-Speech) matching unit, and a plurality of voice synthesizers, a method for performing various voice synthesis functions by controlling said voice synthesizers, comprising the steps of:
causing said client apparatus to supply said TTS matching unit with a voice synthesis request message composed of a text attached with tags defining attributes of said text;
causing said TTS matching unit to select one of said voice synthesizers by analyzing said tags of said message;
causing said TTS matching unit to convert said tags of said text into a format to be recognized by the selected synthesizer based on a tag table containing a collection of tags previously stored for said plurality of voice synthesizers;
causing said TTS matching unit to deliver said text with the tags converted to said selected synthesizer and then to receive the voices synthesized by said synthesizer; and
causing said TTS matching unit to deliver said voices to said client apparatus.

8. A method as defined in claim 7, further comprising:
causing said TTS matching unit to analyze a format of said voice synthesis request message to determine whether said message is effective; and
causing said TTS matching unit to analyze the tags of said message only if said message is effective.

9. A method as defined in claim 7, further comprising:
causing said TTS matching unit to receive a modulation data if the tags of said voice synthesis request message include the attribute of modulation effect; and
causing said TTS matching unit to apply said modulation data to said voices.

10. A method as defined in claim 7, further comprising:
causing said TTS matching unit to apply a sound data to said voices to produce if the tags of said voice synthesis request message include the attribute of sound effect; and
causing said TTS matching unit to deliver the voices mixed with said sound data to said client apparatus.

11. A method as defined in claim 7, wherein said plurality of voice synthesizers generate voices according to different languages and different ages.

12. A method as defined in claim 7, wherein said voice synthesis request message is a tagged text including said text and the tags defining the attributes thereof, said text and tags composed by the user through a GUI writing tool.

13. A method as defined in claim 12, wherein said writing tool is provided with functions of setting an interval and selecting a synthesizer so that the user may select desired voices generated at a desired interval among said text.
